(19) United States
(12) Patent Application Publication
(10) Pub. No.: US 2026/0253436 A1
(43) Pub. Date: Aug. 27, 2026

(54) OPEN VOCABULARY SEMANTIC SEGMENTATION OF IMAGES

(71) Applicant: QUALCOMM Incorporated, San Diego, CA (US)

(72) Inventors: Satyam GABA, San Diego, CA (US); Lokesh JAIN, San Diego, CA (US); Parag Mohan KANADE, San Diego, CA (US); Sony AKKARAKARAN, Poway, CA (US)

(21) Appl. No.: 19/455,497

(22) Filed: Jan. 21, 2026

Related U.S. Application Data
(60) Provisional application No. 63/763,717, filed on Feb. 26, 2025.

(51) Int. Cl. G06V 20/70; G06V 10/764

(52) U.S. Cl. CPC G06V 20/70; G06V 10/764

(57) ABSTRACT

Methods, systems, and devices for semantic segmentation of images are described. In some aspects, a processing pipeline is provided for zero-shot open-vocabulary semantic segmentation of images. An input image (e.g., a RGB image) may be provided to an object proposal generator model that generates proposals for objects in the image and their corresponding masks. The object proposal generator model may provide segmentation masks, such as a cropped portion of the initial image, associated with each identified object to an open vocabulary object classifier model. The open vocabulary object classifier model may assign labels to each segmented region and corresponding mask. The labels from all the masks are combined to produce all the masks for the original input image, to provide a segmented image with associated classifications for each segment.

### CROSS REFERENCES

The present Application for Patent claims benefit of U.S. Provisional Patent Application No. 63/763,717 by GABA et al., entitled “OPEN VOCABULARY SEMANTIC SEGMENTATION OF IMAGES,” filed Feb. 26, 2025, assigned to the assignee hereof, and expressly incorporated herein.

### FIELD OF TECHNOLOGY

The following relates to semantic segmentation of images, including open vocabulary semantic segmentation of images.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for semantic segmentation of images by an apparatus is described. The method may include obtaining an original image, the original image associated with a set of multiple objects, generating a set of multiple masks based on an identification of the set of multiple objects, each mask of the set of multiple masks associated with one of the set of multiple objects, classifying each mask of the set of multiple masks in accordance with an open vocabulary object classifier algorithm to obtain a label associated with each mask that identifies an associated object of the set of multiple objects, and combining the label associated with each mask and the set of multiple masks to generate a segmented image with corresponding mask labels associated with the original image.

An apparatus for semantic segmentation of images is described. The apparatus may include one or more memories storing processor executable code, and one or more processors coupled with the one or more memories. The one or more processors may individually or collectively be operable to execute the code to cause the apparatus to obtain an original image, the original image associated with a set of multiple objects, generate a set of multiple masks based on an identification of the set of multiple objects, each mask of the set of multiple masks associated with one of the set of multiple objects, classify each mask of the set of multiple masks in accordance with an open vocabulary object classifier algorithm to obtain a label associated with each mask that identifies an associated object of the set of multiple objects, and combine the label associated with each mask and the set of multiple masks to generate a segmented image with corresponding mask labels associated with the original image.

Another apparatus for semantic segmentation of images is described. The apparatus may include means for obtaining an original image, the original image associated with a set of multiple objects, means for generating a set of multiple masks based on an identification of the set of multiple objects, each mask of the set of multiple masks associated with one of the set of multiple objects, means for classifying each mask of the set of multiple masks in accordance with an open vocabulary object classifier algorithm to obtain a label associated with each mask that identifies an associated object of the set of multiple objects, and means for combining the label associated with each mask and the set of multiple masks to generate a segmented image with corresponding mask labels associated with the original image.

A non-transitory computer-readable medium storing code for semantic segmentation of images is described. The code may include instructions executable by one or more processors to obtain an original image, the original image associated with a set of multiple objects, generate a set of multiple masks based on an identification of the set of multiple objects, each mask of the set of multiple masks associated with one of the set of multiple objects, classify each mask of the set of multiple masks in accordance with an open vocabulary object classifier algorithm to obtain a label associated with each mask that identifies an associated object of the set of multiple objects, and combine the label associated with each mask and the set of multiple masks to generate a segmented image with corresponding mask labels associated with the original image.

In some examples of the method, apparatuses, and non-transitory computer-readable medium described herein, the original image may be a visible light image. In some examples of the method, apparatuses, and non-transitory computer-readable medium described herein, generating the set of multiple masks may include operations, features, means, or instructions for identifying the set of multiple objects based on an object identification model that identifies candidate objects in accordance with visual characteristics and generating a mask associated with each identified object.

In some examples of the method, apparatuses, and non-transitory computer-readable medium described herein, each mask may be generated in accordance with a segment anything model (SAM) that segments objects in images and provides an associated mask.

In some examples of the method, apparatuses, and non-transitory computer-readable medium described herein, each mask of the set of multiple masks has an associated bounding box within the original image that indicates ordered pairs of coordinates of the original image that contain the associated object, where each bounding box isolates one candidate object.

In some examples of the method, apparatuses, and non-transitory computer-readable medium described herein, generating the set of multiple masks may include operations, features, means, or instructions for generating a cropped image associated with each bounding box, where the cropped image includes the mask with no background, or includes the mask and at least a portion of a background of the original image and providing the cropped image associated with each bounding box for classification.

In some examples of the method, apparatuses, and non-transitory computer-readable medium described herein, each cropped image is provided to the open vocabulary object classifier algorithm. In some examples of the method, apparatuses, and non-transitory computer-readable medium described herein, a contrastive vision-language model, trained on a set of multiple image-text pairs, is used to create the open vocabulary object classifier algorithm. In some examples of the method, apparatuses, and non-transitory computer-readable medium described herein, the contrastive vision-language model includes a text-encoding component and an image encoder component, and provides encoding vectors as outputs. In some examples of the method, apparatuses, and non-transitory computer-readable medium described herein, each encoding vector may be a continuous representation of text or image data in a vector space.

In some examples of the method, apparatuses, and non-transitory computer-readable medium described herein, the text-encoding component includes a set of multiple object categories, and each category is associated with a set of multiple text prompts that is selectable as a label for the associated cropped image. In some examples of the method, apparatuses, and non-transitory computer-readable medium described herein, each text prompt is provided to a text encoder to produce a corresponding text embedding vector. In some examples of the method, apparatuses, and non-transitory computer-readable medium described herein, each cropped image is provided to an image encoder of the contrastive vision-language model to produce an image embedding vector. In some examples of the method, apparatuses, and non-transitory computer-readable medium described herein, classifying each mask of the set of multiple masks may include operations, features, means, or instructions for computing a similarity score between the image embedding vector and each text embedding vector that indicates how closely the associated cropped image matches a corresponding text prompt.

In some examples of the method, apparatuses, and non-transitory computer-readable medium described herein, classifying each mask of the set of multiple masks may include operations, features, means, or instructions for aggregating, for each category of the set of multiple object categories, the similarity score of all text prompts of the associated cropped image to obtain a set of aggregated similarity scores for each cropped image for the set of multiple object categories. In some examples of the method, apparatuses, and non-transitory computer-readable medium described herein, classifying each mask of the set of multiple masks may include operations, features, means, or instructions for generating a probability distribution of the set of aggregated similarity scores and identifying the label associated with each mask based on a highest probability of the probability distribution of the associated cropped image meeting a threshold criterion.

In some examples of the method, apparatuses, and non-transitory computer-readable medium described herein, the generating the set of multiple masks may be performed at a first computing component and the classifying each mask of the set of multiple masks may be performed at a second computing component. In some examples of the method, apparatuses, and non-transitory computer-readable medium described herein, the obtaining the original image includes receiving original image data and text prompts with labels at both the first computing component and the second computing component via one or more application programming interfaces, and where, the first computing component generates segmentation masks and cropped images containing potential objects are extracted, the second computing component converts text prompts into text embeddings and receives the cropped images from the first computing component, and image embeddings are computed and classified against the text embeddings, and the first computing component receives classification information from the second computing component and applies corresponding labels to the set of multiple masks to generate the segmented image with the corresponding mask labels.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports open vocabulary semantic segmentation of images in accordance with one or more aspects of the present disclosure.

FIG. 2 shows an example of a processing pipeline that supports open vocabulary semantic segmentation of images in accordance with one or more aspects of the present disclosure.

FIG. 3 shows an example of processing steps that support open vocabulary semantic segmentation of images in accordance with one or more aspects of the present disclosure.

FIG. 4 shows an example of an open vocabulary object classifier that supports open vocabulary semantic segmentation of images in accordance with one or more aspects of the present disclosure.

FIG. 5 shows an example of a process flow that supports open vocabulary semantic segmentation of images in accordance with one or more aspects of the present disclosure.

FIGS. 6 and 7 show block diagrams of devices that support open vocabulary semantic segmentation of images in accordance with one or more aspects of the present disclosure.

FIG. 8 shows a block diagram of a semantic segmentation entity that supports open vocabulary semantic segmentation of images in accordance with one or more aspects of the present disclosure.

FIG. 9 shows a diagram of a system including a UE that supports open vocabulary semantic segmentation of images in accordance with one or more aspects of the present disclosure.

FIG. 10 shows a diagram of a system including a network entity that supports open vocabulary semantic segmentation of images in accordance with one or more aspects of the present disclosure.

FIG. 11 shows a flowchart illustrating methods that support open vocabulary semantic segmentation of images in accordance with one or more aspects of the present disclosure.

### DETAILED DESCRIPTION

Image processing techniques may be used to provide information related to images and various objects that may be included in images. Such information related to objects in an image may have numerous uses. For example, images may be used to help generate models associated with applications such as automotive applications (e.g., vision-based driver assistance), augmented reality (AR), virtual reality (VR), or other computer vision related tasks. In other examples, images may be used by entities such as wireless network operators, controllers, providers, or planners/developers that may create and use radio frequency (RF) models associated with a geographic area to help make decisions, predictions, or estimations associated with an area, such as for a wireless communications system located within the geographic area. While some examples discussed herein are related to wireless communications and RF models that may be developed based on segmented images, techniques as discussed herein may be used in numerous other situations, and the various aspects discussed herein are not limited to development of RF models.

As described herein, a geographic area may include an indoor area (e.g., inside a building or structure), an outdoor area, or any combination of one or more indoor areas and one or more outdoor areas. In some cases, a RF model may be generated based in part on an image a geographic area, which may enable interested parties to use digital models to (at least approximately) replicate one or more devices, objects, processes, or conditions of the geographic area (or of the wireless communications system) and perform simulations within a virtual representation of the geographic area. Such simulations performed using the image of an area and associated objects may provide insight into how devices, objects, processes, or conditions of a real-world version of the geographic area interact or perform, among other examples. For example, a model associated with a geographic area may be used to simulate, predict, or estimate one or more RF metrics associated with wireless communications within the geographic area, based on provided images in which objects of the images may be labeled in order to generate an RF model based on RF characteristics of different objects (e.g., based on whether an object reflects RF signals, absorbs RF signals, or attenuates RF signals).

In order to provide an accurate model associated with an area, in some cases, one or more images of the area may be provided that include labels associated with various objects of the image. However, existing techniques for object identification may attempt to generate tags for all objects in an image (e.g., in RAM-Grounded-SAM techniques), or may receive text prompts associated with an image and attempt to detect corresponding objects in the image (e.g., in Grounded SAM techniques). Such techniques rely on detection of individual objects in images, which may be a challenging task. Thus, techniques for identification and classification of objects in an image may be desirable.

Various aspects generally relate to a computer vision (CV) pipeline for zero-shot open-vocabulary semantic segmentation of images. In some aspects, an image (e.g., a red-green-blue (RGB) image) may be provided as input to the pipeline. The provided image goes through an object proposal generator model (which may be referred to as Module 1) that generates proposals for objects in the image and their corresponding masks. The object proposal generator model may provide segmentation masks (e.g., a cropped portion of the initial image) associated with each identified object to an open vocabulary object classifier model (which may be referred to as Module 2). The open vocabulary object classifier model may assign labels to each segmented region and corresponding mask. In some aspects, the open vocabulary object classifier model may have a configurable threshold that corresponds to the minimum confidence level of the classifier for the masks. The labels from all the masks are combined to produce all the masks for the original input image. In some aspects, the CV pipeline does not require any extra pre-training and provides segmentation performance without fine-tuning. Further, it may segment objects of arbitrary size, ratio, or orientation, in images, and can segment tiny objects as effectively as large objects. Additionally, the CV pipeline may provide reliable performance on relatively low-quality images or when the test data differs from the training data, and may perform classification in cases of domain shift or multiple variants (e.g., changing seasons or geography) without requiring fine-tuning. In some aspects, a low rank adapter (LoRA) may be added to CLIP image encoders to improve performance in cases of relatively substantial domain shifts, such as digital twins or low Lighting Quality.

Aspects of the disclosure are initially described in the context of wireless communications systems. Aspects of the disclosure are further illustrated by and described with reference to process flows, apparatus diagrams, system diagrams, and flowcharts that relate to open vocabulary semantic segmentation of images.

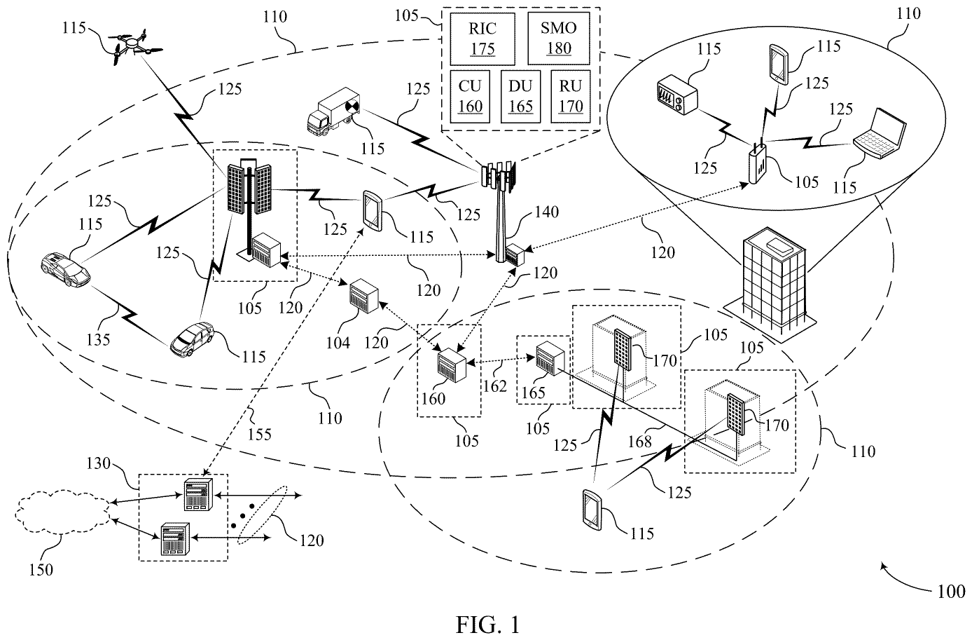

FIG. 1 shows an example of a wireless communications system 100 that supports open vocabulary semantic segmentation of images in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support open vocabulary semantic segmentation of images as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be located within a geographic area and, in some cases, a network operator, controller, provider, or planner/developer may create and use a RF model associated with the geographic area to help make decisions, predictions, or estimations associated with the wireless communications system 100. The network operator, controller, provider, or planner/developer may use images of the area, for example, to generate a digital twin to model a physical environment in a virtual environment (e.g., a virtual world) and, instead of or in addition to performing measurements or tests within the physical environment, may perform measurements or tests using the model of the physical environment. Using wireless raytracing, one or more transmitters and one or more receivers may be placed within the three-dimensional model and RF paths between the one or more transmitters and the one or more receivers may be raytraced to generate data, with such data being usable to perform studies to predict, estimate, or otherwise determine one or more metrics associated with wireless communications within the geographic area. A network operator, controller, provider, or planner/developer may use such data and/or metrics to make decisions associated with a real-world version of the wireless communications system 100, as such data and/or metrics may approximate actual data and/or metrics that might have been obtained if measurements or tests within the physical environment were performed.

In some implementations, one or more communication devices, nodes, or entities of the wireless communications system 100 may support techniques associated with semantic segmentation of images. Segmented images may include one or more labels associated with one or more corresponding objects in the image which, in some examples, may be used to generate an RF model associated with the imaged area.

As described herein, a processing pipeline is provided for zero-shot open-vocabulary semantic segmentation of images. In some aspects, an image (e.g., a RGB image) may be provided as input to the pipeline. The image may be provided to an object proposal generator model (Module 1) that generates proposals for objects in the image and their corresponding masks. The object proposal generator model may provide segmentation masks (e.g., a cropped portion of the initial image) associated with each identified object to an open vocabulary object classifier model (Module 2). The open vocabulary object classifier model may assign labels to each segmented region and corresponding mask. In some aspects, the open vocabulary object classifier model may have a configurable threshold that corresponds to the minimum confidence level of the classifier for the masks. The labels from all the masks are combined to produce all the masks for the original input image.

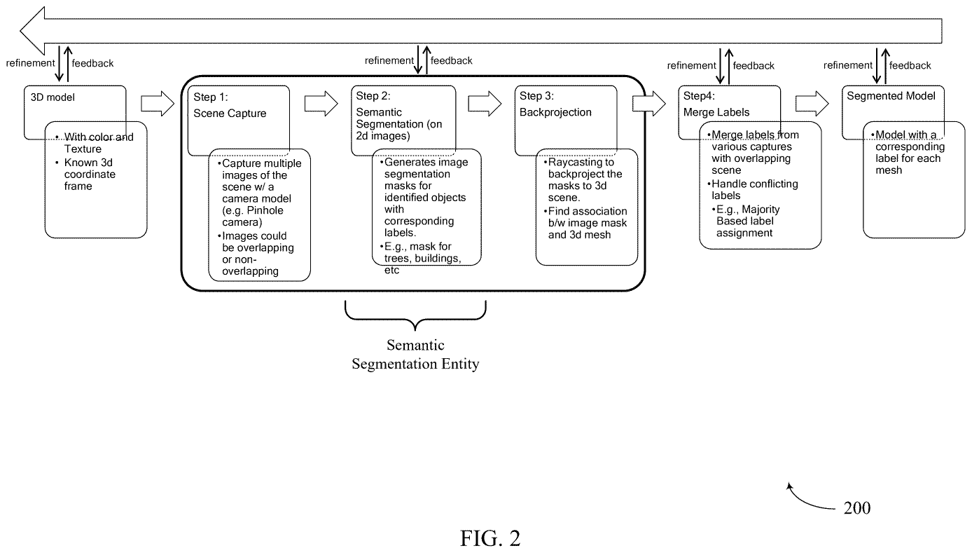

FIG. 2 shows an example of a processing pipeline 200 that supports open vocabulary semantic segmentation of images in accordance with one or more aspects of the present disclosure. In accordance with the processing pipeline 200, a semantic segmentation entity may obtain an original image of an area, identify one or more objects in the image and corresponding masks, and assign labels to identified objects, to produce a semantic segmentation of the provided image.

As discussed herein, in some wireless communications systems, one or more characteristics associated with a geographic area may impact wireless communications, such as RF propagation, especially at relatively higher frequencies (e.g., FR2 or FR4 frequencies, among other examples). Such characteristics may include (tree or bush) foliage, structures, or materials of structures, among other examples. Accordingly, accurate identification of objects is needed in order to identify associated RF characteristics and provide an accurate RF model. For example, accurate RF models of real-world environments may be important for near-over-the-air (OTA) performance evaluations in wireless simulations. Since these simulations often involve ray-tracing with realistic material properties, both the geometry (i.e., shape) and the material assignments (e.g., dielectric constants, reflection coefficients) based on object labels should be highly accurate.

In accordance with the example processing pipeline of FIG. 2, a 3D model may be provided for 3D semantic segmentation (e.g., based on scene capture, semantic segmentation, and back projection). Back projection may refer to a technique according to which a three-dimensional model is “imaged” from one or more known virtual camera positions (within the three-dimensional model) to obtain unsegmented two-dimensional images. The 3D semantic segmentation may be merged with labels associated with materials, to provide a segmented model with a corresponding label for each mesh (e.g., each mesh triangle of the 3D model). In some examples, such a model may be used in RF simulations, as discussed herein. In some aspects, feedback may be provided to each processing function that may be used to refine associated processing.

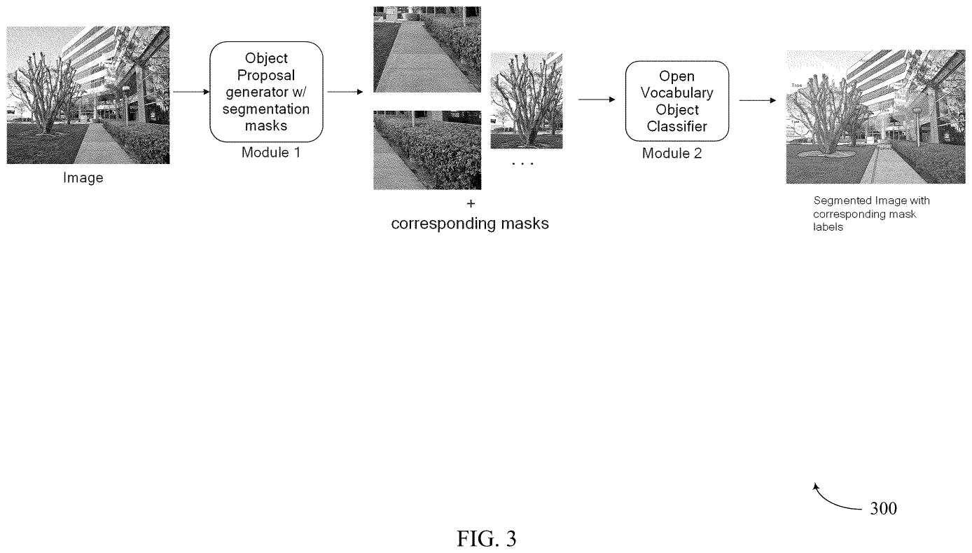

With respect to the semantic segmentation entity, zero-shot segmentation based on a foundation model is common in the field of computer vision. Semantic segmentation models traditionally are trained for a set of vocabulary and predict a mask based on the data's limited vocabulary. Such techniques require re-training to add another class, and these models are susceptible to domain shifts, including concept and temporal changes. More recently, foundation segmentation models have been available, such as the Segment Anything Model (SAM) trained on large dataset (e.g., billions of images). These model have high inductive bias (e.g., can extract good segmentation masks for objects of arbitrary shapes). Further, there are other classes of foundation models that can correlate between text and images, such as the CLIP (Contrastive Language-Image Pre-Training) Model of Open AI. The CLIP model has a text encoder and an image encoder, and is trained to map image and text pairs to close vicinity in the embedding space. Therefore, the texts and images embedding of different classes of objects form tight intra-class clusters and well-separated intra class clusters. In some aspects, this can be exploited to create CLIP based classifier that works on open-vocabulary. In aspects discussed herein, aspects of both of these techniques are used to create a zero-shot open-vocabulary semantic segmentation model. Such a model can be used in Autonomous systems, augmented reality (AR), virtual reality (VR), digital twin generation, or any other computer vision related application. FIGS. 3 through 5 show examples of various aspects of image segmentation and object classification. Such examples illustrate aspects of a processing pipeline for zero-shot open-vocabulary semantic segmentation that does not require any extra pre-training and exhibits; provides reliable performance without fine-tuning; can segment objects of arbitrary size, ratio, or orientation in images; can segment small objects as effectively as larger objects, provides reliable segmentation and classification of low-quality images or when the test data differs from the training data, and provides reliable classification in cases of domain shift or multiple variants without requiring fine-tuning. Further, in some aspects, a low rank adapter (LoRA) to CLIP image encoder may be implemented in conjunction with the semantic segmentation entity to further enhance performance in cases of major domain shifts, such as digital twins or low lighting quality.

In some aspects, the processing pipeline may segment objects in a 3D mesh without modifying the original mesh. The pipeline may be based on pretrained 2D image segmentation models and does not require any additional training for 3D segmentation tasks, which may make the pipeline scalable and general purpose. The model may provide high quality dense segments for 3D models of arbitrary shapes and sizes, is open-vocabulary such that it can segment various different 3D object types in 3D scenes, and has a robust mechanism for labeling the mesh. Further, in the event that one or more objects are unlabeled or incorrectly labeled, a merging algorithm may provide a correct result.

FIG. 3 shows an example of processing steps 300 that support open vocabulary semantic segmentation of images in accordance with one or more aspects of the present disclosure. In this example, an RGB image is provided as an input to an object proposal generator. The object proposal generator (Module 1) may generate proposals for objects in the image and their corresponding masks (e.g., binary segmentations of the image). Each segmented region (e.g., cropped part of the image) may be processed through an open vocabulary object classifier (Module 2), which may assign labels to the segmented regions and their corresponding masks. The classifier may have a configurable threshold that corresponds to the minimum confidence level of the classifier for the masks. The labels from the masks are combined to produce masks for the original input image.

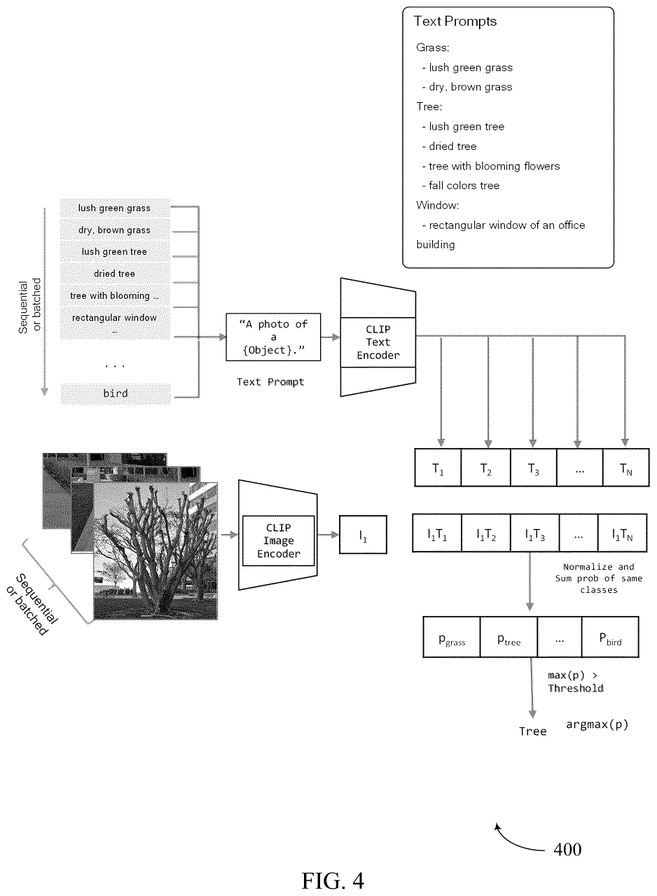

In some aspects, the object proposal generator may receive images (e.g., RGB images) that are provided to a model (e.g., a segment anything model (SAM)) that identifies potential objects by producing segmentation masks, where each mask corresponds to a candidate object in the image. For each mask, a bounding box may be computed using (x_{min_mask}, y_{min_mask}), (x_{max_mask}, y_{max_mask}), along with, optionally, some padding. In some aspects, each bounding box may isolate one potential object. The object proposal generator may then extract cropped images, where crops are taken from the bounding boxes. Depending on scene or performance, these cropped images can either contain only the masked region (i.e., no background), or retain some or all the original image background. The resulting cropped images may be fed into an open-vocabulary classifier (e.g., based on CLIP). In some aspects, the classifier may use contrastive (metric) learning to produce object labels. An example of a classifier is shown in FIG. 4.

FIG. 4 shows an example of an open vocabulary object classifier 400 that supports open vocabulary semantic segmentation of images in accordance with one or more aspects of the present disclosure. The open vocabulary object classifier 400 may implement, or be implemented by, aspects of FIGS. 1 through 3.

In the example of FIG. 4, each cropped image from Module 1 may pass into a zero-shot classification stage. In some aspects, a contrastive vision-language model (e.g., CLIP) may be used, trained on image-text pair, to create an open-vocabulary classifier. In some cases, CLIP has a text-encoding and an image encoding component which give embedding vectors as outputs, where each embedding vector is a continuous representation of the text or image data in a vector space. In some aspects, text encodings may be generated in accordance with prompt creation and an embedding computation. For prompt creation, for each category (e.g., Grass, Tree, Window), multiple text prompts are created to capture variations. For example, prompts may be generated and/or refined using prompt engineering or a large language model (LLM). For the embedding computation, each prompt may be fed into the text encoder to produce a corresponding text embedding vector. In some aspects, all text prompts may be batched together for efficiency.

Image encoding may be performed at an image encoder (e.g., CLIP image encoder), where each image goes through the model's image encoder to produce an image embedding vector. A similarity score may be computed (e.g., dot product or cosine similarity) between the image embedding and each text embedding, and represents how closely the image matched each text prompt. For each broad category (e.g., Grass or Tree), a sum or average of the similarity scores of all its associated text prompts is computed, which may help ensure there is no intra-category competition among variants of the same label. A final classification may be determined, such as by applying a softmax to the aggregated similarity scores to obtain a probability distribution. In some aspects, if the highest probability exceeds a set or configurable threshold value, the category label associated with the highest probability is output from the model. Otherwise, the image may be assigned no label (e.g., “background” or “no class”). Such techniques provide an open vocabulary where new classes can be introduced at inference simply by adding relevant text prompts. Further, different text prompts for the same label help capture variations without reducing each other's score, and thus such techniques provide no intra-class competition.

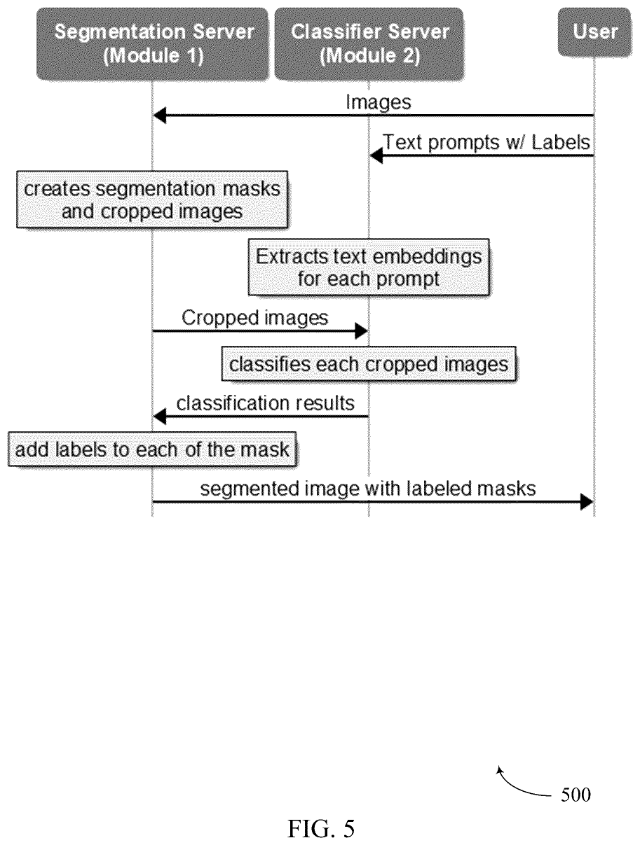

FIG. 5 shows an example of a process flow 500 that supports open vocabulary semantic segmentation of images in accordance with one or more aspects of the present disclosure. In some cases, the process flow 500 may implement or be implemented by aspects of FIGS. 1 through 4. For example, the process flow 500 may include segmentation server (module 1) and a classifier server (module 2), which may be examples of the corresponding devices as described herein, and a user device that may provide image and text prompts with labels to the segmentation server and the classifier server. In the process flow 500, the operations between the segmentation server, classifier server, and user device, may be performed in a different order than the example order shown, or may be performed in different orders or at different times. Some operations may also be omitted from the process flow 500, and other operations may be added to the process flow 500.

In this example, processing for image segmentation and classification is spread across multiple servers each running a dedicated module. For example, the user device may provide input, in the form of images that are provided to segmentation server and text prompts with labels that are provided to classifier server. In some cases, a user may upload raw image and text prompts with labels to both segmentation server (Module 1) and classifier server (Module 2) via one or more application programming interfaces (APIs). The segmentation server may process the image, generating segmentation masks, and cropped regions containing potential objects are extracted.

The classification server may convert text prompts into embeddings. Further, the cropped images from the segmentation server may be provided to the classification server, where image embeddings are computed and classified against the text embedding, such as discussed with reference to FIG. 4. The classification results may be provided to the segmentation server, which may apply labels to the corresponding segmentation masks. The final output may be provided back to the user device as a segmented image with labeled masks.

Such techniques may provide underlying models that are trained on large-scale real-world datasets spanning across diverse scenes and conditions. As a result, they generalize well to new domains and can handle previously unseen objects with minimal or no fine-tuning. Further, the processing pipeline in various aspects uses a CLIP-based contrastive learning approach for image classification, which is simpler yet more robust than conventional object detection workflows (e.g., Detection followed by masking). Such a design is more tolerant of domain shifts. Further, the system may support multiple object variations (e.g., different shapes, textures, or forms), improving performance on objects variants like “Dry grass,” “Green grass” and “Tall Grass,” yielding high accuracy in classification. Additionally, because the pipeline relies on independent text embeddings, new classes or variants can be introduced simply by adding relevant prompts, with no retraining or re-computing other embeddings. This makes the system easy to adapt and scale to new scenes. Such techniques are also robust to occlusions and scale changes by localizing and classifying smaller regions, such that the model retains high accuracy even when objects are partially occluded or vary in size.

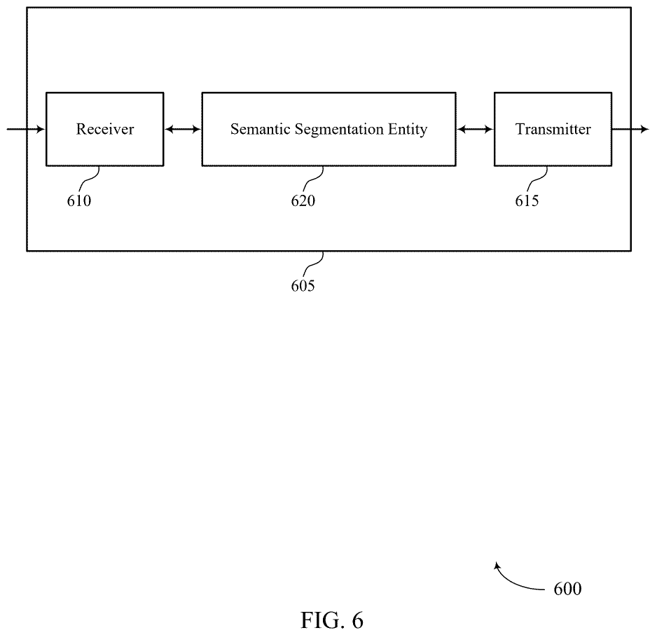

FIG. 6 shows a block diagram 600 of a device 605 that supports open vocabulary semantic segmentation of images in accordance with one or more aspects of the present disclosure. The device 605 may be an example of aspects of a segmentation server, a UE 115, or a network entity 105 as described herein. The device 605 may include a receiver 610, a transmitter 615, and a semantic segmentation entity 620. The device 605, or one or more components of the device 605 (e.g., the receiver 610, the transmitter 615, the semantic segmentation entity 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to open vocabulary semantic segmentation of images). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to open vocabulary semantic segmentation of images). In some examples, the transmitter 615 may be co-located with a receiver 610 in a transceiver module. The transmitter 615 may utilize a single antenna or a set of multiple antennas.

The semantic segmentation entity 620, the receiver 610, the transmitter 615, or various combinations or components thereof may be examples of means for performing various aspects of open vocabulary semantic segmentation of images as described herein. For example, the semantic segmentation entity 620, the receiver 610, the transmitter 615, or various combinations or components thereof may be capable of performing one or more of the functions described herein.

In some examples, the semantic segmentation entity 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the semantic segmentation entity 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the semantic segmentation entity 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the semantic segmentation entity 620 may be configured to perform various operations (e.g., receiving, obtaining, monitoring, outputting, transmitting) using or otherwise in cooperation with the receiver 610, the transmitter 615, or both. For example, the semantic segmentation entity 620 may receive information from the receiver 610, send information to the transmitter 615, or be integrated in combination with the receiver 610, the transmitter 615, or both to obtain information, output information, or perform various other operations as described herein.

The semantic segmentation entity 620 may support semantic segmentation of images in accordance with examples as disclosed herein. For example, the semantic segmentation entity 620 is capable of, configured to, or operable to support a means for obtaining an original image associated with a set of multiple objects. The semantic segmentation entity 620 is capable of, configured to, or operable to support a means for generating a set of multiple masks based on an identification of the set of multiple objects, each mask of the set of multiple masks associated with one of the set of multiple objects. The semantic segmentation entity 620 is capable of, configured to, or operable to support a means for classifying each mask of the set of multiple masks in accordance with an open vocabulary object classifier algorithm to obtain a label associated with each mask that identifies the associated object of the set of multiple objects. The semantic segmentation entity 620 is capable of, configured to, or operable to support a means for combining the label associated with each mask and the set of multiple masks to generate a segmented image with corresponding mask labels associated with the original image.

By including or configuring the semantic segmentation entity 620 in accordance with examples as described herein, the device 605 (e.g., at least one processor controlling or otherwise coupled with the receiver 610, the transmitter 615, the semantic segmentation entity 620, or a combination thereof) may support techniques for efficient semantic segmentation of images, which may provide for more efficient segmentation of images that is flexible, robust, adaptable, and scalable to new scenes.

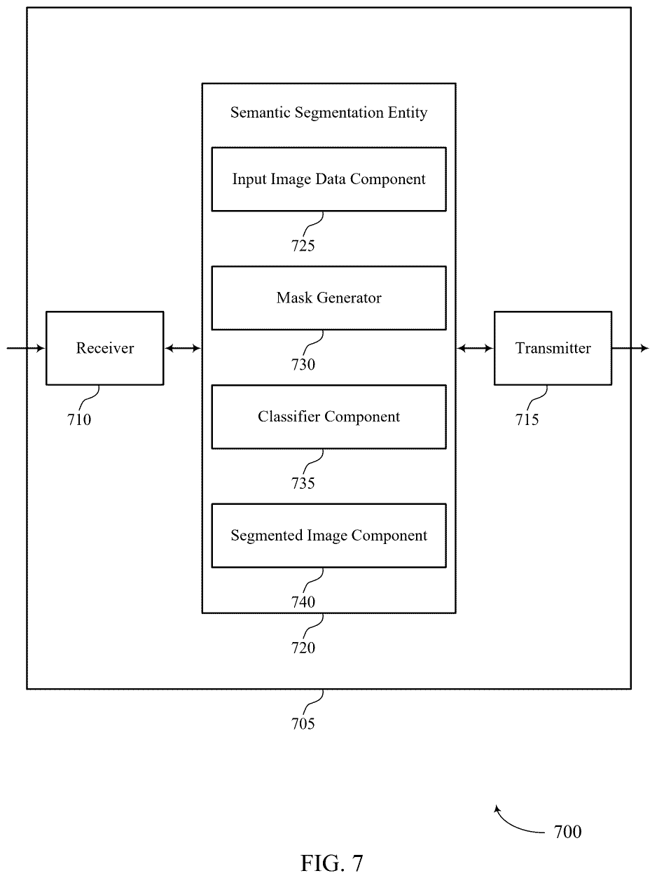

FIG. 7 shows a block diagram 700 of a device 705 that supports open vocabulary semantic segmentation of images in accordance with one or more aspects of the present disclosure. The device 705 may be an example of aspects of a device 605, a segmentation server, a UE, or a network entity 105 as described herein. The device 705 may include a receiver 710, a transmitter 715, and a semantic segmentation entity 720. The device 705, or one or more components of the device 705 (e.g., the receiver 710, the transmitter 715, the semantic segmentation entity 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to open vocabulary semantic segmentation of images). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to open vocabulary semantic segmentation of images). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of open vocabulary semantic segmentation of images as described herein. For example, the semantic segmentation entity 720 may include an input image data component 725, a mask generator 730, a classifier component 735, a segmented image component 740, or any combination thereof. The semantic segmentation entity 720 may be an example of aspects of a semantic segmentation entity 620 as described herein. In some examples, the semantic segmentation entity 720, or various components thereof, may be configured to perform various operations (e.g., receiving, obtaining, monitoring, outputting, transmitting) using or otherwise in cooperation with the receiver 710, the transmitter 715, or both. For example, the semantic segmentation entity 720 may receive information from the receiver 710, send information to the transmitter 715, or be integrated in combination with the receiver 710, the transmitter 715, or both to obtain information, output information, or perform various other operations as described herein.

The semantic segmentation entity 720 may support semantic segmentation of images in accordance with examples as disclosed herein. The input image data component 725 is capable of, configured to, or operable to support a means for obtaining an original image associated with a set of multiple objects. The mask generator 730 is capable of, configured to, or operable to support a means for generating a set of multiple masks based on an identification of the set of multiple objects, each mask of the set of multiple masks associated with one of the set of multiple objects. The classifier component 735 is capable of, configured to, or operable to support a means for classifying each mask of the set of multiple masks in accordance with an open vocabulary object classifier algorithm to obtain a label associated with each mask that identifies the associated object of the set of multiple objects. The segmented image component 740 is capable of, configured to, or operable to support a means for combining the label associated with each mask and the set of multiple masks to generate a segmented image with corresponding mask labels associated with the original image.

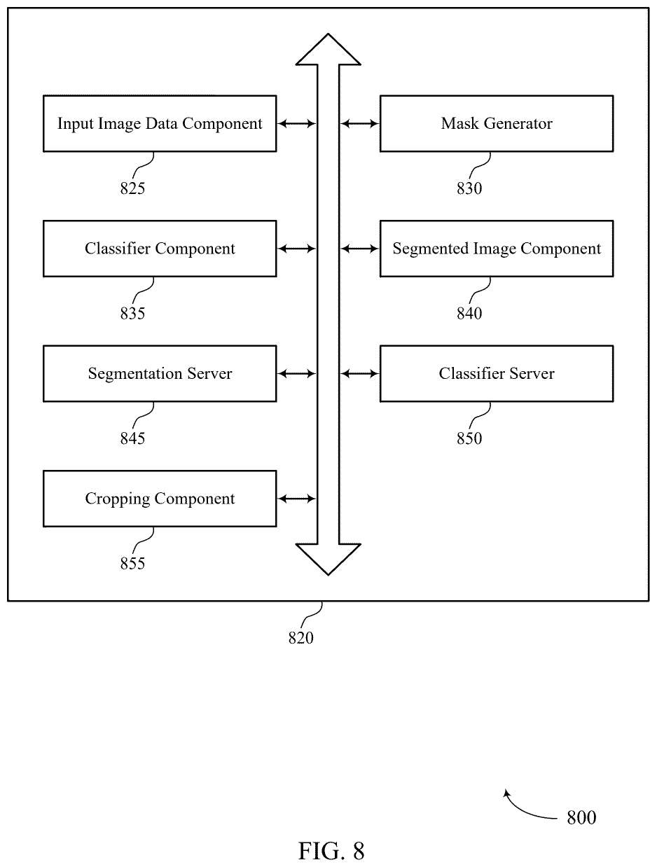

FIG. 8 shows a block diagram 800 of a semantic segmentation entity 820 that supports open vocabulary semantic segmentation of images in accordance with one or more aspects of the present disclosure. The semantic segmentation entity 820 may be an example of aspects of a semantic segmentation entity 620, a semantic segmentation entity 720, or both, as described herein. The semantic segmentation entity 820, or various components thereof, may be an example of means for performing various aspects of open vocabulary semantic segmentation of images as described herein. For example, the semantic segmentation entity 820 may include an input image data component 825, a mask generator 830, a classifier component 835, a segmented image component 840, a segmentation server 845, a classifier server 850, a cropping component 855, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The semantic segmentation entity 820 may support semantic segmentation of images in accordance with examples as disclosed herein. The input image data component 825 is capable of, configured to, or operable to support a means for obtaining an original image associated with a set of multiple objects. The mask generator 830 is capable of, configured to, or operable to support a means for generating a set of multiple masks based on an identification of the set of multiple objects, each mask of the set of multiple masks associated with one of the set of multiple objects. The classifier component 835 is capable of, configured to, or operable to support a means for classifying each mask of the set of multiple masks in accordance with an open vocabulary object classifier algorithm to obtain a label associated with each mask that identifies the associated object of the set of multiple objects. The segmented image component 840 is capable of, configured to, or operable to support a means for combining the label associated with each mask and the set of multiple masks to generate a segmented image with corresponding mask labels associated with the original image. In some examples, the original image is a visible light image.

In some examples, to support generating the set of multiple masks, the mask generator 830 is capable of, configured to, or operable to support a means for identifying the set of multiple objects based on an object identification model that identifies candidate objects in accordance with visual characteristics. In some examples, to support generating the set of multiple masks, the mask generator 830 is capable of, configured to, or operable to support a means for generating a mask associated with each identified object. In some examples, each mask is generated in accordance with a segment anything model (SAM) that segments objects in images and provides an associated mask. In some examples, each mask of the set of multiple masks has an associated bounding box within the original image that indicates ordered pairs of coordinates of the original image that contain the associated object, where each bounding box isolates one candidate object.

In some examples, to support generating the set of multiple masks, the cropping component 855 is capable of, configured to, or operable to support a means for generating a cropped image associated with each bounding box, where the cropped image includes the mask with no background, or includes the mask and at least a portion of a background of the original image. In some examples, to support generating the set of multiple masks, the cropping component 855 is capable of, configured to, or operable to support a means for providing the cropped image associated with each bounding box for classification. In some examples, each cropped image is provided to the open vocabulary object classifier algorithm. In some examples, a contrastive vision-language model, trained on a set of multiple image-text pairs, is used to create the open vocabulary object classifier algorithm. In some examples, the contrastive vision-language model includes a text-encoding component and an image encoder component, and provides encoding vectors as outputs. In some examples, the encoding vector is a continuous representation of text or image data in a vector space. In some examples, the text-encoding component includes a set of multiple object categories, and each category is associated with a set of multiple text prompts that are selectable as a label for the associated cropped image. In some examples, each text prompt is provided to a text encoder to produce a corresponding text embedding vector. In some examples, each cropped image is provided to an image encoder of the contrastive vision-language model to produce an image embedding vector.

In some examples, to support classifying each mask of the set of multiple masks, the classifier component 835 is capable of, configured to, or operable to support a means for computing a similarity score between the image embedding vector and each text embedding vector that indicates how closely the associated cropped image matches the corresponding text prompt. In some examples, to support classifying each mask of the set of multiple masks, the classifier component 835 is capable of, configured to, or operable to support a means for aggregating, for each category of the set of multiple object categories, the similarity score of all text prompts of the associated cropped image to obtain a set of aggregated similarity scores for each cropped image for the set of multiple object categories. In some examples, to support classifying each mask of the set of multiple masks, the classifier component 835 is capable of, configured to, or operable to support a means for generating a probability distribution of the set of aggregated similarity scores. In some examples, to support classifying each mask of the set of multiple masks, the classifier component 835 is capable of, configured to, or operable to support a means for identifying the label associated with each mask based on a highest probability of the probability distribution of the associated cropped image meeting a threshold criterion.

In some examples, the generating the set of multiple masks is performed at a first computing component and the classifying each mask of the set of multiple masks is performed at a second computing component. In some examples, the obtaining the original image of the locality includes receiving original image data and text prompts with labels at both the first computing component and the second computing component via one or more application programming interfaces. In some examples, the first computing component generates segmentation masks and cropped images containing potential objects are extracted. In some examples, the second computing component converts text prompts into text embeddings and receives the cropped images from the first computing component, and image embeddings are computed and classified against the text embeddings. In some examples, the first computing component receives classification information from the second computing component and applies corresponding labels to the set of multiple masks to generate the segmented image with corresponding mask labels.

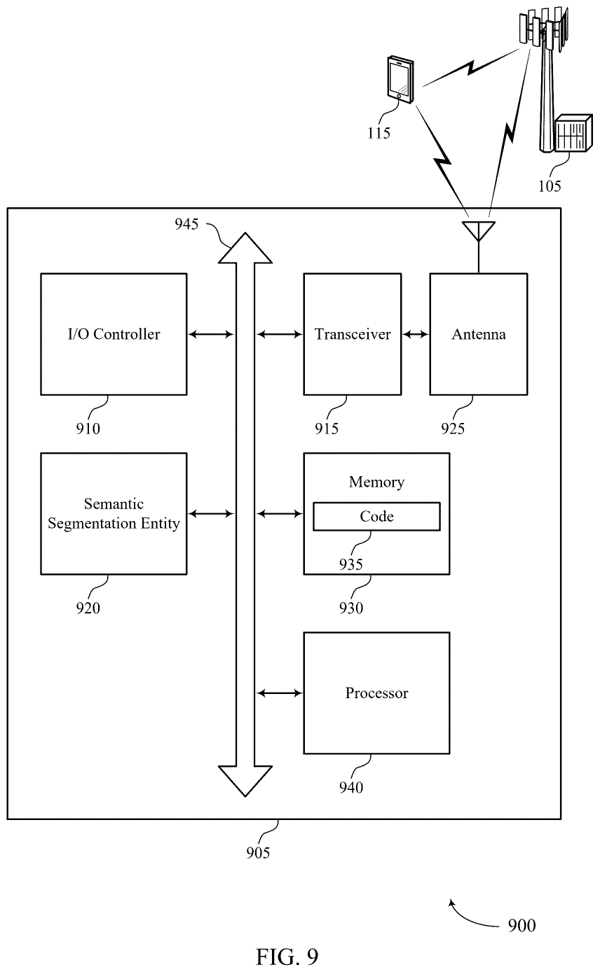

FIG. 9 shows a diagram of a system 900 including a device 905 that supports open vocabulary semantic segmentation of images in accordance with one or more aspects of the present disclosure. The device 905 may be an example of or include components of a device 605, a device 705, a segmentation server, or a UE as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a semantic segmentation entity 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting open vocabulary semantic segmentation of images). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The semantic segmentation entity 920 may support semantic segmentation of images in accordance with examples as disclosed herein. For example, the semantic segmentation entity 920 is capable of, configured to, or operable to support a means for obtaining an original image associated with a set of multiple objects. The semantic segmentation entity 920 is capable of, configured to, or operable to support a means for generating a set of multiple masks based on an identification of the set of multiple objects, each mask of the set of multiple masks associated with one of the set of multiple objects. The semantic segmentation entity 920 is capable of, configured to, or operable to support a means for classifying each mask of the set of multiple masks in accordance with an open vocabulary object classifier algorithm to obtain a label associated with each mask that identifies the associated object of the set of multiple objects. The semantic segmentation entity 920 is capable of, configured to, or operable to support a means for combining the label associated with each mask and the set of multiple masks to generate a segmented image with corresponding mask labels associated with the original image.

By including or configuring the semantic segmentation entity 920 in accordance with examples as described herein, the device 905 may support techniques for efficient semantic segmentation of images, which may provide for more efficient segmentation of images that is flexible, robust, adaptable, and scalable to new scenes.

In some examples, the semantic segmentation entity 920 may be configured to perform various operations (e.g., receiving, monitoring, transmitting) using or otherwise in cooperation with the transceiver 915, the one or more antennas 925, or any combination thereof. Although the semantic segmentation entity 920 is illustrated as a separate component, in some examples, one or more functions described with reference to the semantic segmentation entity 920 may be supported by or performed by the at least one processor 940, the at least one memory 930, the code 935, or any combination thereof. For example, the code 935 may include instructions executable by the at least one processor 940 to cause the device 905 to perform various aspects of open vocabulary semantic segmentation of images as described herein, or the at least one processor 940 and the at least one memory 930 may be otherwise configured to, individually or collectively, perform or support such operations.

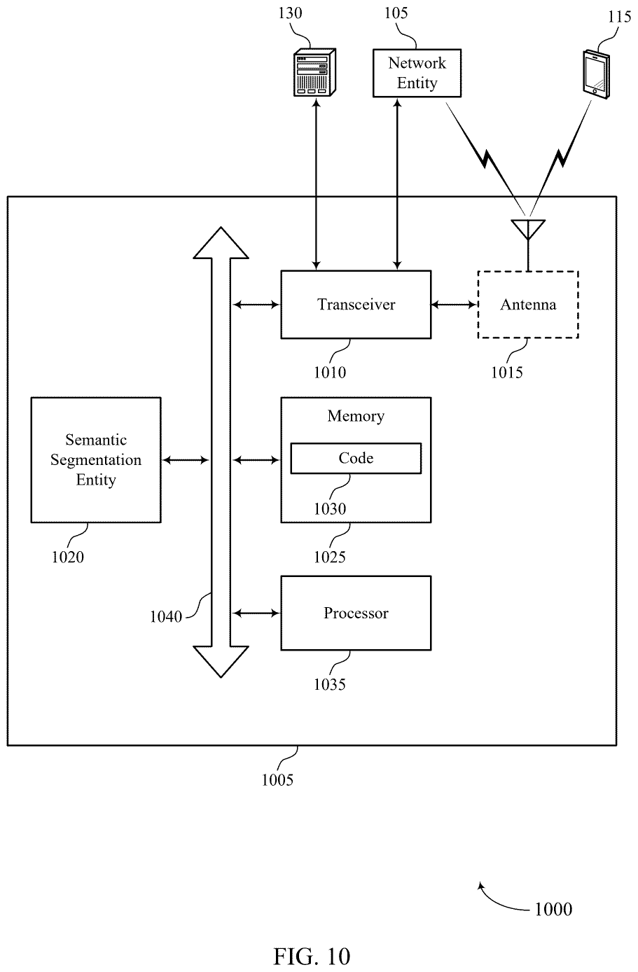

FIG. 10 shows a diagram of a system 1000 including a device 1005 that supports open vocabulary semantic segmentation of images in accordance with one or more aspects of the present disclosure. The device 1005 may be an example of or include components of a device 605, a device 705, a segmentation server, or a network entity as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a semantic segmentation entity 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting open vocabulary semantic segmentation of images). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the semantic segmentation entity 1020, the transceiver 1010, the at least one memory 1025, the code 1030, and the at least one processor 1035 may be located in one of the different components or divided between different components).

In some examples, the semantic segmentation entity 1020 may manage aspects of communications with a core network 130 (e.g., via one or more wired or wireless backhaul links). For example, the semantic segmentation entity 1020 may manage the transfer of data communications for client devices, such as one or more UEs 115. In some examples, the semantic segmentation entity 1020 may manage communications with one or more other network entities 105, and may include a controller or scheduler for controlling communications with UEs 115 (e.g., in cooperation with the one or more other network devices). In some examples, the semantic segmentation entity 1020 may support an X2 interface within an LTE/LTE-A wireless communications network technology to provide communication between network entities 105.

The semantic segmentation entity 1020 may support semantic segmentation of images in accordance with examples as disclosed herein. For example, the semantic segmentation entity 1020 is capable of, configured to, or operable to support a means for obtaining an original image associated with a set of multiple objects. The semantic segmentation entity 1020 is capable of, configured to, or operable to support a means for generating a set of multiple masks based on an identification of the set of multiple objects, each mask of the set of multiple masks associated with one of the set of multiple objects. The semantic segmentation entity 1020 is capable of, configured to, or operable to support a means for classifying each mask of the set of multiple masks in accordance with an open vocabulary object classifier algorithm to obtain a label associated with each mask that identifies the associated object of the set of multiple objects. The semantic segmentation entity 1020 is capable of, configured to, or operable to support a means for combining the label associated with each mask and the set of multiple masks to generate a segmented image with corresponding mask labels associated with the original image.

By including or configuring the semantic segmentation entity 1020 in accordance with examples as described herein, the device 1005 may support techniques for efficient semantic segmentation of images, which may provide for more efficient segmentation of images that is flexible, robust, adaptable, and scalable to new scenes.

In some examples, the semantic segmentation entity 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the semantic segmentation entity 1020 is illustrated as a separate component, in some examples, one or more functions described with reference to the semantic segmentation entity 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of open vocabulary semantic segmentation of images as described herein, or the at least one processor 1035 and the at least one memory 1025 may be otherwise configured to, individually or collectively, perform or support such operations.

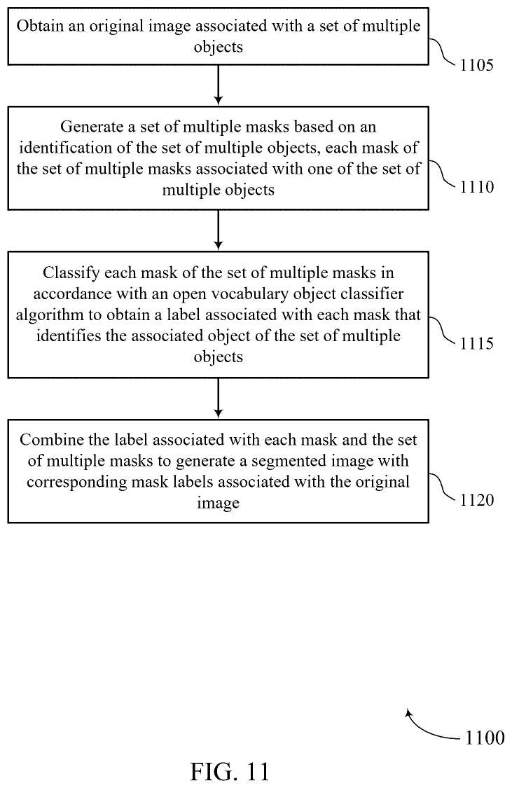

FIG. 11 shows a flowchart illustrating a method 1100 that supports open vocabulary semantic segmentation of images in accordance with one or more aspects of the present disclosure. The operations of the method 1100 may be implemented by a segmentation server, a UE, or a network entity or its components as described herein. For example, the operations of the method 1100 may be performed by a segmentation server, a UE, or a network entity as described with reference to FIGS. 1 through 10. In some examples, a segmentation server, a UE, or a network entity may execute a set of instructions to control the functional elements of the segmentation server, the UE, or the network entity to perform the described functions. Additionally, or alternatively, the segmentation server, the UE, or the network entity may perform aspects of the described functions using special-purpose hardware.

At 1105, the method may include obtaining an original image associated with a set of multiple objects. The operations of 1105 may be performed in accordance with examples as disclosed herein. In some examples, aspects of the operations of 1105 may be performed by an input image data component 825 as described with reference to FIG. 8.

At 1110, the method may include generating a set of multiple masks based on an identification of the set of multiple objects, each mask of the set of multiple masks associated with one of the set of multiple objects. The operations of 1110 may be performed in accordance with examples as disclosed herein. In some examples, aspects of the operations of 1110 may be performed by a mask generator 830 as described with reference to FIG. 8.

At 1115, the method may include classifying each mask of the set of multiple masks in accordance with an open vocabulary object classifier algorithm to obtain a label associated with each mask that identifies the associated object of the set of multiple objects. The operations of 1115 may be performed in accordance with examples as disclosed herein. In some examples, aspects of the operations of 1115 may be performed by a classifier component 835 as described with reference to FIG. 8.

At 1120, the method may include combining the label associated with each mask and the set of multiple masks to generate a segmented image with corresponding mask labels associated with the original image. The operations of 1120 may be performed in accordance with examples as disclosed herein. In some examples, aspects of the operations of 1120 may be performed by a segmented image component 840 as described with reference to FIG. 8.

The following provides an overview of aspects of the present disclosure:

Aspect 1: A method for semantic segmentation of images, comprising: obtaining an original image, the original image associated with a plurality of objects; generating a plurality of masks based at least in part on an identification of the plurality of objects, each mask of the plurality of masks associated with one of the plurality of objects; classifying each mask of the plurality of masks in accordance with an open vocabulary object classifier algorithm to obtain a label associated with each mask that identifies an associated object of the plurality of objects; and combining the label associated with each mask and the plurality of masks to generate a segmented image with corresponding mask labels associated with the original image.

Aspect 2: The method of aspect 1, wherein the original image is a visible light image.

Aspect 3: The method of any of aspects 1 through 2, wherein generating the plurality of masks comprises: identifying the plurality of objects based at least in part on an object identification model that identifies candidate objects in accordance with visual characteristics; and generating a mask associated with each identified object.

Aspect 4: The method of aspect 3, wherein each mask is generated in accordance with a segment anything model (SAM) that segments objects in images and provides an associated mask.

Aspect 5: The method of any of aspects 3 through 4, wherein each mask of the plurality of masks has an associated bounding box within the original image that indicates ordered pairs of coordinates of the original image that contain the associated object, wherein each bounding box isolates one candidate object.

Aspect 6: The method of aspect 5, wherein generating the plurality of masks further comprises: generating a cropped image associated with each bounding box, wherein the cropped image includes the mask with no background, or includes the mask and at least a portion of a background of the original image; and providing the cropped image associated with each bounding box for classification.

Aspect 7: The method of aspect 6, wherein each cropped image is provided to the open vocabulary object classifier algorithm.

Aspect 8: The method of any of aspects 6 through 7, wherein a contrastive vision-language model, trained on a plurality of image-text pairs, is used to create the open vocabulary object classifier algorithm.

Aspect 9: The method of aspect 8, wherein the contrastive vision-language model includes a text-encoding component and an image encoder component, and provides encoding vectors as outputs.

Aspect 10: The method of aspect 9, wherein each encoding vector is a continuous representation of text or image data in a vector space.

Aspect 11: The method of any of aspects 9 through 10, wherein the text-encoding component includes a plurality of object categories, and each category is associated with a plurality of text prompts that are selectable as a label for an associated cropped image.

Aspect 12: The method of aspect 11, wherein each text prompt is provided to a text encoder to produce a corresponding text embedding vector.

Aspect 13: The method of aspect 12, wherein each cropped image is provided to an image encoder of the contrastive vision-language model to produce an image embedding vector.

Aspect 14: The method of aspect 13, wherein classifying each mask of the plurality of masks further comprises: computing a similarity score between the image embedding vector and each text embedding vector that indicates how closely the associated cropped image matches a corresponding text prompt.

Aspect 15: The method of aspect 14, wherein classifying each mask of the plurality of masks further comprises: aggregating, for each category of the plurality of object categories, the similarity score of all text prompts of the associated cropped image to obtain a set of aggregated similarity scores for each cropped image for the plurality of object categories.

Aspect 16: The method of aspect 15, wherein classifying each mask of the plurality of masks further comprises: generating a probability distribution of the set of aggregated similarity scores; and identifying the label associated with each mask based at least in part on a highest probability of the probability distribution of the associated cropped image meeting a threshold criterion.

Aspect 17: The method of any of aspects 1 through 16, wherein the generating the plurality of masks is performed at a first computing component and the classifying each mask of the plurality of masks is performed at a second computing component.

Aspect 18: The method of aspect 17, wherein the obtaining the original image comprises receiving original image data and text prompts with labels at both the first computing component and the second computing component via one or more application programming interfaces, and wherein: the first computing component generates segmentation masks and cropped images containing potential objects are extracted, the second computing component converts text prompts into text embeddings and receives the cropped images from the first computing component, and image embeddings are computed and classified against the text embeddings, and the first computing component receives classification information from the second computing component and applies corresponding labels to the plurality of masks to generate the segmented image with the corresponding mask labels.

Aspect 19: An apparatus for semantic segmentation of images, comprising one or more memories storing processor-executable code, and one or more processors coupled with the one or more memories and individually or collectively operable to execute the code to cause the apparatus to perform a method of any of aspects 1 through 18.

Aspect 20: An apparatus for semantic segmentation of images, comprising at least one means for performing a method of any of aspects 1 through 18.

Aspect 21: A non-transitory computer-readable medium storing code for semantic segmentation of images, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for semantic segmentation of images, comprising:
one or more memories storing processor-executable code; and
one or more processors coupled with the one or more memories and individually or collectively operable to execute the code to cause the apparatus to:
obtain an original image associated with a plurality of objects;
generate a plurality of masks based at least in part on an identification of the plurality of objects, each mask of the plurality of masks associated with one of the plurality of objects;
classify each mask of the plurality of masks in accordance with an open vocabulary object classifier algorithm to obtain a label associated with each mask that identifies an associated object of the plurality of objects; and
combine the label associated with each mask and the plurality of masks to generate a segmented image with corresponding mask labels associated with the original image.

2. The apparatus of claim 1, wherein the original image is a visible light image.

3. The apparatus of claim 1, wherein, to generate the plurality of masks, the one or more processors are individually or collectively operable to execute the code to cause the apparatus to:
identify the plurality of objects based at least in part on an object identification model that identifies candidate objects in accordance with visual characteristics; and
generate a mask associated with each identified object.

4. The apparatus of claim 3, wherein each mask is generated in accordance with a segment anything model (SAM) that segments objects in images and provides an associated mask.

5. The apparatus of claim 3, wherein each mask of the plurality of masks has an associated bounding box within the original image that indicates ordered pairs of coordinates of the original image that contain the associated object, wherein each bounding box isolates one candidate object.

6. The apparatus of claim 5, wherein, to generate the plurality of masks, the one or more processors are individually or collectively further operable to execute the code to cause the apparatus to:
generate a cropped image associated with each bounding box, wherein the cropped image includes the mask with no background, or includes the mask and at least a portion of a background of the original image; and
provide the cropped image associated with each bounding box for classification.

7. The apparatus of claim 6, wherein each cropped image is provided to the open vocabulary object classifier algorithm.

8. The apparatus of claim 6, wherein a contrastive vision-language model, trained on a plurality of image-text pairs, is used to create the open vocabulary object classifier algorithm.

9. The apparatus of claim 8, wherein the contrastive vision-language model includes a text-encoding component and an image encoder component, and provides encoding vectors as outputs.

10. The apparatus of claim 9, wherein each encoding vector is a continuous representation of text or image data in a vector space.

11. The apparatus of claim 9, wherein the text-encoding component includes a plurality of object categories, and each category is associated with a plurality of text prompts that are selectable as a label for an associated cropped image.

12. The apparatus of claim 11, wherein each text prompt is provided to a text encoder to produce a corresponding text embedding vector.

13. The apparatus of claim 12, wherein each cropped image is provided to an image encoder of the contrastive vision-language model to produce an image embedding vector.

14. The apparatus of claim 13, wherein, to classify each mask of the plurality of masks, the one or more processors are individually or collectively further operable to execute the code to cause the apparatus to:
compute a similarity score between the image embedding vector and each text embedding vector that indicates how closely the associated cropped image matches a corresponding text prompt.

15. The apparatus of claim 14, wherein, to classify each mask of the plurality of masks, the one or more processors are individually or collectively further operable to execute the code to cause the apparatus to:
aggregate, for each category of the plurality of object categories, the similarity score of all text prompts of the associated cropped image to obtain a set of aggregated similarity scores for each cropped image for the plurality of object categories.

16. The apparatus of claim 15, wherein, to classify each mask of the plurality of masks, the one or more processors are individually or collectively further operable to execute the code to cause the apparatus to:
generate a probability distribution of the set of aggregated similarity scores; and
identify the label associated with each mask based at least in part on a highest probability of the probability distribution of the associated cropped image meeting a threshold criterion.

17. The apparatus of claim 1, wherein the generating the plurality of masks is performed at a first computing component and the classifying each mask of the plurality of masks is performed at a second computing component.

18. The apparatus of claim 17, wherein:
the obtaining the original image comprises receiving original image data and text prompts with labels at both the first computing component and the second computing component via one or more application programming interfaces, and wherein:
the first computing component generates segmentation masks and cropped images containing potential objects are extracted,
the second computing component converts text prompts into text embeddings and receives the cropped images from the first computing component, and image embeddings are computed and classified against the text embeddings, and
the first computing component receives classification information from the second computing component and applies corresponding labels to the plurality of masks to generate the segmented image with the corresponding mask labels.

19. A method for semantic segmentation of images, comprising:
obtaining an original image associated with a plurality of objects;
generating a plurality of masks based at least in part on an identification of the plurality of objects, each mask of the plurality of masks associated with one of the plurality of objects;
classifying each mask of the plurality of masks in accordance with an open vocabulary object classifier algorithm to obtain a label associated with each mask that identifies an associated object of the plurality of objects; and
combining the label associated with each mask and the plurality of masks to generate a segmented image with corresponding mask labels associated with the original image.

20. A non-transitory computer-readable medium storing code for semantic segmentation of images, the code comprising instructions executable by one or more processors to:
obtain an original image associated with a plurality of objects;
generate a plurality of masks based at least in part on an identification of the plurality of objects, each mask of the plurality of masks associated with one of the plurality of objects;
classify each mask of the plurality of masks in accordance with an open vocabulary object classifier algorithm to obtain a label associated with each mask that identifies an associated object of the plurality of objects; and
combine the label associated with each mask and the plurality of masks to generate a segmented image with corresponding mask labels associated with the original image.
